(19) United States
(12) Patent Application Publication
(10) Pub. No.: US 2024/0190745 A1
(43) Pub. Date: Jun. 13, 2024

(54) METHOD FOR THE TREATMENT OF BLACK WATER

(71) Applicant: NOAH WATER SOLUTIONS BV, Gavere (BE)

(72) Inventors: Rik VAN MEIRHAEGHE, Gavere (BE); Dries PARMENTIER, Gavere (BE); Jef VAN MEIRHAEGHE, Gavere (BE); Roemer GOOSSENSEN, Gavere (BE)

(21) Appl. No.: 18/572,023

(22) PCT Filed: Jun. 21, 2022
(86) PCT No.: PCT/IB2022/055746

§ 371 Date: Dec. 19, 2023

(30) Foreign Application Priority Data
Jun. 21, 2021 (BE) BE2021/5484

(51) Int. Cl. C02F 9/00; B60R 15/04; B61D 35/00; B63J 4/00; B64D 11/02; C02F 1/00; C02F 1/28; C02F 1/461; C02F 1/463; C02F 1/467; C02F 101/32; C02F 103/00

(52) U.S. Cl. CPC C02F 9/00; B60R 15/04; B61D 35/007; B63J 4/006; B64D 11/02; C02F 1/001; C02F 1/283; C02F 1/46109; C02F 2001/46138; C02F 2001/46171; C02F 1/463; C02F 1/4674; C02F 2101/32; C02F 2103/005; C02F 2201/008; C02F 2301/046; C02F 2301/08; C02F 2303/04; C02F 2303/26

(57) ABSTRACT

In a first aspect, the present application relates to a method for the treatment of black water, comprising the steps of: collecting black water; treating said black water in an electrocoagulation cell with iron or aluminum electrode, such that electrocoagulation effluent and electrocoagulation sludge are obtained; separating the electrocoagulation sludge from the electrocoagulation effluent; disinfecting said electrocoagulation effluent in an electro-oxidation cell with a titanium or stainless-steel electrode, obtaining disinfected effluent. In a further aspect, the current application relates to a closed toilet system.

### TECHNICAL FIELD

The invention relates to a method for removing contaminants from black water by electroflotation or electrocoagulation, in which the wastewater to be cleaned is passed through an asymmetrical electrolytic cell, resulting in a cell reaction in which both metal hydroxide and hydrogen gas are produced. For metal hydroxides with low solubility, impurities coagulate with the metal hydroxides into flocs.

### PRIOR ART

Electrocoagulation is the coagulation or flocculation of dissolved or suspended solids using electricity. At the cathode, the electrolytic cell produces a gas, usually hydrogen gas. At the anode, the electrolytic cell produces metal ions. These ions act as coagulants for the impurities in the wastewater. The gas provides a buoyant effect for the resulting flocs, which are then mechanically separated from the water.

Electrocoagulation is known from US patent publications U.S. Pat. Nos. 5,888,359 and 6,086,732.

A problem with black water is that, given high environmental standards, it cannot be discharged without intense treatment. A problem with existing electrocoagulation setups is that they either clean too much or do not clean enough to convert black water into water of dischargeable quality.

### SUMMARY OF THE INVENTION

In the first aspect, the invention comprises a method for the treatment of black water according to claim 1.

This method allows advantageously and with a small cleaning module to treat black water very effectively to dischargeable quality.

A particularly preferred embodiment of the first aspect is described in claim 3. This method allows to reuse treated black water as a flush for a toilet.

In a second aspect, the invention relates to a closed toilet system according to claim 12.

In general, the use of black water, whether or not treated and cleaned, as flushing water is avoided due to color and odor problems. The current method cleans black water sufficiently to be used as flushing water, forming a closed black water cycle. This advantageously makes it possible to prevent dilution of black water, so that more efficient cleaning is obtained due to the higher concentrations of contamination, less storage is necessary and separate flushing water and black water storage is unnecessary.

In a third aspect, the invention relates to the use of the method according to the first aspect or a closed toilet system according to the second aspect for cleaning black water in a means of transport or a residence which is not connected to a sewerage system, including temporary residences such as motor homes. In particular, the present method is suitable for cleaning black water from boats and trains. The arrangement according to the present invention allows for on-site treatment of black water from toilets and utilities until the water is within discharge standards and/or to close the black water cycle and reuse the treated black water as flushing water. In this way, fewer or no large reservoirs for flushing water and stored black water are necessary.

### DESCRIPTION OF THE FIGURES

FIG. 1: A schematic overview of an embodiment of the electrolytic cell according to the present invention.

FIG. 2A: A schematic overview of an embodiment of ultrasonic cleaning according to the present invention.

FIG. 2B: A detail view of an embodiment of ultrasonic cleaning according to the present invention.

FIG. 3A: A schematic overview of an embodiment of cleaning with vane-shaped brushes according to the present invention.

FIG. 3B: A detail view of an embodiment of cleaning with vane-shaped brushes according to the present invention.

FIG. 4A: A schematic overview of an embodiment of pressure wave or jet cleaning according to the present invention.

FIG. 4B: A detail view of a preferred embodiment of a jet cap according to the present invention.

FIG. 5A: A schematic representation of a first embodiment of the method according to the present invention.

FIG. 5B: A schematic representation of a second embodiment of the method according to the present invention.

FIG. 6A: A schematic representation of an embodiment of the method according to the present invention.

FIG. 6B: A schematic representation of a preferred embodiment of the method according to the present invention with recycling.

FIG. 7A: A schematic representation of a preferred embodiment of the method according to the present invention.

FIG. 7B: A schematic representation of a preferred embodiment of the method according to the present invention with recycling.

### DETAILED DESCRIPTION

The invention relates to a method for removing contaminants by means of a combination of electro-oxidation and electro-coagulation. The invention also relates to a device and assembly for purifying wastewater.

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “encompass”, “encompassing”, “contain”, “containing”, are synonyms and are inclusive or open terms that indicate the presence of what follows, and which do not exclude or prevent the presence of other components, characteristics, elements, members, steps, as known from or disclosed in the prior art.

“Electrocoagulation” is the coagulation (flocculation) of dissolved or suspended solids using electricity. “Electroflotation” comprises electrocoagulation, with the additional step of releasing gas bubbles that bring the coagulated flocs to the surface. An “electrocoagulation cell” is a combination of an “electrolytic cell” and a “separation device”, preferably a floc tower suitable for separating coagulated flocs and treated water.

“Electro-oxidation” (EO) is the oxidation of chemical components in a liquid flow using an electrolytic cell. In “electro-oxidation (EO)”, “anodic oxidation” or “electrochemical oxidation”, oxidizing agents are formed. The most common setup consists of two electrodes, which act as anode and cathode, and are connected to a power source. When an energy supply and sufficient supporting electrolyte are supplied to the system, strong oxidizing agents are formed which interact with and break down the contaminants.

Quoting numerical intervals by endpoints comprises all integers, fractions and/or real numbers between the endpoints, these endpoints included.

“Black water” is wastewater with high levels of contamination, including biological contamination and a high risk of pathogens. Typically, black water is wastewater from bathrooms and toilets that contains feces and urine. Highly contaminated water with high concentrations of bacteria from other sources is also considered black water. After some time, this water usually takes on a black color due to the bacterial rotting process.

“Gray water” is the wastewater that comes from sinks, washing machines, bathtubs, and showers. It contains fewer contaminants, making it easier to handle and process.

In a first aspect, the invention relates to a method for the treatment of black water, comprising the steps of:
a. collecting black water;
b. treating said black water in an electrocoagulation cell with iron or aluminum electrode, such that electrocoagulation effluent and electrocoagulation sludge are obtained;
c. separating the electrocoagulation sludge from the electrocoagulation effluent;
d. optionally filtering the electrocoagulation effluent, preferably with a mesh size smaller than 50 μm, obtaining filtered effluent,
e. disinfecting said electrocoagulation effluent in an electro-oxidation cell with a titanium or stainless-steel electrode, obtaining disinfected effluent.

The disinfected effluent, after optional post-treatments, is treated black water. This treated black water contains significantly less contaminants than the original black water. Advantageously, these results can be obtained without any dilution.

In a preferred embodiment, the treated black water meets the applicable discharge standards. In a further preferred embodiment, the treated black water can be discharged to surface water. This is particularly advantageous for applications exploited near surface water, especially boats, more especially small boats such as pleasure boats and river boats. Some regional discharge standards prohibit or limit the dilution of black water with dilution water. A method that efficiently processes black water without the need for dilution water is therefore desirable.

In a preferred embodiment, the treated black water is used for flushing a toilet. In a preferred embodiment, the disinfected effluent is used for flushing a toilet. In a further preferred embodiment, the treated black water, before it is used for flushing a toilet, is again passed through an electro-oxidation cell with a titanium electrode. More preferably, the same electro-oxidation cell is used for both the oxidative treatment of electrocoagulation effluent and the treatment of already treated black water which is recycled as flushing water. This is advantageous for immediately counteracting the growth of bacteria in the fresh black water, originating from, for example, a toilet, and thus to keep the BOD thereof low.

Preferably, the electrocoagulation effluent is first filtered before being treated in the titanium electro-oxidation cell. Preferably, a filter membrane is used. The removal of iron particles or colloidal iron is beneficial to promote the life of the titanium electrolytic cell. In a further preferred embodiment the electrocoagulation effluent is filtered, preferably with a mesh size smaller than 100 μm, more preferably having a mesh size smaller than 50 μm, more preferably having a mesh size smaller than 25 μm, more preferably having a mesh size smaller than 20 μm, more preferably having a mesh size smaller than 15 μm, more preferably having a mesh size smaller than 10 μm, more preferably having a mesh size smaller than 5 μm.

In another preferred embodiment, step C. comprises a sufficiently good separation between electrocoagulation sludge, consisting of usually floating coagulated flocs, and electrocoagulation effluent that a filtration step is unnecessary. In particular, sufficient separation of sludge and effluent, so that small colloidal particles coagulate and/or are separated with the sludge is advantageous since a filtration step is not necessary. This also saves space, weight, and maintenance.

In a preferred embodiment, the treated black water undergoes one or more post-treatments. In a further preferred embodiment, this post-treatment is a UV treatment, a filtration step, preferably nanofiltration, aeration, or a post-treatment with a titanium electro-oxidation cell or a post-treatment with an iron electrocoagulation cell or a sorption process. Depending on the degree of pollution of the black water and the quality requirements for discharge, such post-treatments are necessary or desirable to guarantee the quality of the treated black water. It is particularly important that the black water always meets the strictest requirements after treatment if it cannot be stored, and thus is always discharged and/or the black water is reused, for example as flushing water.

In a preferred embodiment, the disinfected effluent is post-treated. In a further preferred embodiment, the disinfected effluent obtained is post-treated with a filtration step. Preferably, this comprises a filtration step with a mesh size smaller than 5 μm, more preferably smaller than 3 μm, more preferably smaller than 1 μm, more preferably smaller than 0.5 μm, more preferably smaller than 0.2 μm, more preferably smaller than 0.1 μm, more preferably less than 0.08 μm, more preferably less than 0.06 μm, more preferably less than 0.05 μm, more preferably less than 0.02 μm, more preferably less than 0.01 μm. In another preferred embodiment, the post-treatment involves a sorption process, for example an adsorption or absorption process. Sorption processes are advantageously suitable for targeted removal of rather specific contaminants. For example, ad or absorbents suitable for the removal of specific contaminants such as manganese are available. A drawback of sorption processes is that they are generally poorly suited for treating highly contaminated water such as black water, inter alia due to rapid deactivation, saturation or poisoning of the sorbent. As a result, a sorption process is preferably used as a post-treatment. More preferably, the post-treatment concerns a treatment with activated carbon as sorbent. Activated carbon is a suitable sorbent for a large group of molecules, in particular small and medium-sized hydrocarbons. In a particularly preferred embodiment, post-treatment is carried out with a filtration step and a sorption process. Preferably first a filtration step, followed by a sorption process. This makes it possible to replace and/or regenerate the sorbent less regularly.

In a second aspect, the invention relates to a closed toilet system comprising:
a toilet, the toilet having a flushing water inlet and a toilet outlet,
a macerator pump, the macerator pump having a macerator pump inlet and a macerator pump outlet, the toilet outlet being in fluid communication with the macerator pump outlet,
an electrocoagulation cell with iron or aluminum electrode, provided with a separation mechanism for separating electrocoagulation effluent and sludge, the electrocoagulation cell having an electrocoagulation inlet, a sludge outlet, and an effluent outlet,
optionally a first filter, the first filter being provided for filtering the effluent outlet, wherein the first filter has a mesh size of less than 50 μm,
an electro-oxidation cell with titanium or stainless-steel electrode, which has an electro-oxidation inlet and an electro-oxidation outlet, wherein the electro-oxidation inlet is in fluid communication with the effluent outlet downstream from the filter, and
a storage tank, wherein the electro-oxidation outlet is in fluid communication with the storage tank, and wherein the storage tank is in fluid communication with the flushing water inlet of the toilet.

In a preferred embodiment, the separation mechanism is based on flotation. At the cathode of the electrolytic cell, hydrogen gas H₂ produced. This hydrogen gas pushes coagulated flocs to the top of the wastewater. This allows to separate water and effluent on the basis of flotation, wherein the flocs are separated at the top of the effluent.

In a preferred embodiment, the closed toilet system comprises the first filter for filtering the effluent outlet, preferably having a mesh size smaller than 100 μm, more preferably having a mesh size smaller than 50 μm, more preferably having a mesh size smaller than 25 μm, more preferably having a mesh size smaller than 20 μm, more preferably having a mesh size smaller than 15 μm, more preferably having a mesh size smaller than 10 μm, more preferably having a mesh size smaller than 5 μm.

In a preferred embodiment, the closed toilet system comprises a second filter, suitable for filtering the electro-oxidation outlet. Preferably, this comprises a filtration step with a mesh size smaller than 5 μm, more preferably smaller than 3 μm, more preferably smaller than 1 μm, more preferably smaller than 0.5 μm, more preferably smaller than 0.1 μm.

In a preferred embodiment, the closed toilet system comprises a sorption column, the sorption column comprising a sorption inlet and sorption outlet, wherein the sorption inlet is in fluid communication with the electro-oxidation outlet. More preferably the sorption column comprises a sorbent, preferably the sorbent comprises activated carbon, more preferably the sorbent contains activated carbon.

In a further preferred embodiment, an electro-oxidation cell is located in the fluid communication between the storage tank and the flushing water inlet. More preferably, the same electro-oxidation cell can be used to (oxidatively) treat effluent from the electrocoagulation cell, as well as (oxidatively) treat stored and treated black water from the storage tank to be used as flushing water. This advantageously increases the concentration of oxidizers in the flushing water. In this way, the growth of bacteria in black water is immediately slowed down or stopped. In this way the BOD of the water to be treated remains low, rather than increasing exponentially before the treatment of the black water.

In a third aspect, the invention relates to the use of the method according to the first aspect or the closed toilet system according to the second aspect on a means of transport or a temporary residence. Preferably, the means of transport or temporary residence is selected from the list of: a boat, train, aircraft, camper, trailer, bus, submarine or drilling platform, more preferably a train.

The invention has been described as a method for the treatment of black water. This is in particular because this method is suitable for counteracting odor nuisance and exponential bacterial growth inherent in black water. It goes without saying, however, that water containing less contamination, in particular gray water, can also be treated using the current method.

The first and second aspects advantageously allow to completely close the water cycle.

In a preferred embodiment, little, preferably no, dilution water is used. Using dilution water, optionally as flushing water, has several disadvantages:
Diluting polluted water such as black water lowers the concentrations of pollution, making it more difficult to treat.
More and more jurisdictions do not allow dilution of black water or limit the dilution that is permissible.
Dilution water and/or flushing water must be available, via pipeline, surface water or storage.
Diluting black water increases the volume of water that must be treated, stored and ultimately discharged.

Before black water can be passed through an electrolytic cell, it is usually first collected in a reservoir, and optionally passed through a macerator pump. This is usually necessary to ensure the proper functioning of the electrolytic cell. However, untreated black water is a breeding ground for bacteria, fungi and the like. As a result, the BOD of black water also increases exponentially during these operations. This can be partially counteracted by flushing with recycled, treated black water. Since this black water has passed through an electro-oxidation cell, the water contains oxidative substances, which strongly inhibit the growth of biological organisms. This also significantly lowers the BOD of the final mixture to be treated and significantly increases the efficiency of the entire process. In addition, odor nuisance is counteracted.

The titanium electrolytic cell is preferably a coaxial electrolytic cell comprising a titanium electrode. More preferably, a titanium electrode and a stainless-steel electrode are used. Alternatively, the electrolytic cell may consist of a titanium electrode and a stable alloy. More preferably, this alloy is stable during a polarity change. More preferably, the titanium electrolytic cell is an electro-oxidation cell. Treating the dilution water with electro-oxidation leads to the formation of (strongly) oxidizing agents. These strong oxidizing agents can in turn break down contaminants present in the black water. The titanium electrode may be coated with one or more elements from the ruthenium group, rhodium group and/or platinum group. In another embodiment, the electro-oxidation cell may also utilize a tin electrode, preferably a tin electrode doped with platinum, ruthenium or rhodium.

The electrocoagulation cell is preferably a coaxial electrolytic cell, preferably comprising at least one monopolar iron electrode and one monopolar stainless-steel electrode provided with a device for separating coagulation flocs and treated water, preferably a floc tower. Other electrodes such as aluminum or copper or alloys of one of the mentioned elements can also be used for this.

In a preferred embodiment, step b., treating the diluted black water by means of an iron or aluminum coagulation cell is performed more than once. In a more preferred embodiment, step b., treating the diluted black water is carried out 2, 3, 4, 5 or 6 times. The effluent from the iron or aluminum electrocoagulation cell is then reused as influent from the same or a successive iron or aluminum electrocoagulation cell. In this way a strong cleaning is obtained. If the same iron or aluminum electrocoagulation cell is used, the size of the overall setup can be reduced.

In a preferred embodiment of the present invention, the solid matter in the black water, in particular feces and the like, is sent through a macerator pump, thereby reducing the size of the solid particles. This allows black water to be pumped more easily, avoids blockages and improves the functioning of the electrocoagulation cell. In a first embodiment, only black water is passed through the macerator pump. This allows to reduce the flow rate to be treated by the macerator pump. In a second embodiment, black water is mixed with treated dilution water before being passed through the macerator pump. This reduces the growth and build-up of bacteria in the macerator pump.

In a preferred embodiment, the black water has sufficient conductivity before treatment with electrocoagulation cell (step b.) and/or electro-oxidation cell (step e.). More preferably the conductivity of the water to be treated is at least 0.5 mS/cm, even more preferably the water to be treated has a conductivity of at least 0.7 mS/cm, even more preferably the water to be treated has a conductivity of at least 0.8 mS/cm, even more preferably the water to be treated has a conductivity of at least 0.9 mS/cm, even more preferably the water to be treated has a conductivity of at least 1.0 mS/cm. If the water to be treated is insufficiently conductive, electrolytes can be added. Preferably the electrolytes used are a salt, more preferably a chloride salt, most preferably sodium chloride. Preferably, the conductivity is mainly derived from chloride salts, but calcium and magnesium ions are avoided. Calcium and magnesium ions lead to contamination of the electrodes, which reduces the functioning of the electrolytic cells. If treated black water is recycled as flushing water in a closed system according to the present invention, this salt can also be added in the storage tank.

In a preferred embodiment, treated black water is used as flushing water and/or dilution water. In this way, the black water and flushing water and/or dilution water are treated in a closed loop. Before rinsing, it remains advantageous to treat the recycled black water with an electro-oxidation cell to produce treated flushing water and/or dilution water, which is mixed with new black water. This way, bacterial growth and odor nuisance can be counteracted immediately.

In one embodiment, part of the treated black water can be discharged by means of an overflow. Alternatively, the treated black water can be collected in a reservoir, wherein this reservoir can be emptied when desirable or necessary, for example to pass this water on to wastewater treatment or sewage.

In one embodiment, treated dilution water is mixed with black water in a reservoir. In another embodiment, treated dilution water is immediately mixed with produced black water. Treated dilution water can thus be used to flush a toilet. In such an arrangement, bacteria and other organisms do not get the chance to grow, which means that the BOD of the mixture is kept significantly lower.

In a preferred embodiment, aeration can be used as pre-treatment and/or post-treatment. In a more preferred embodiment, aeration of the black water is utilized as a pre-treatment in electrocoagulation cells with an iron electrode. In another more preferred embodiment, aeration of the black water is utilized as a post-treatment in aluminum electrode electrocoagulation cells.

In a preferred embodiment, the current intensity of the titanium electrolytic cell or titanium electro-oxidation cell is at least 0.1 A, more preferably at least 0.5 A, more preferably at least 1.0 A, more preferably at least 2.0 A, more preferably at least 3.0 A, more preferably at least 4.0 A, more preferably at least 5.0 A, most preferably 6.0 A. In a preferred embodiment, the current intensity of the titanium electrolytic cell or titanium electro-oxidation cell is at most 15 A, preferably at most 12 A, more preferably at most 10 A.

In a preferred embodiment, the magnitude of the current density of the titanium electrolytic cell or titanium electro-oxidation cell is at least 4 A/m², more preferably at least 20 A/m², more preferably at least 40 A/m², more preferably at least 80 A/m², more preferably at least 120 A/m², more preferably at least 160 A/m², more preferably at least 200 A/m², most preferably 240 A/m². In a preferred embodiment, the magnitude of the current density of the titanium electrolytic cell or titanium electro-oxidation cell is at most 600 A/m², more preferably at most 480 A/m², more preferably at most 400 A/m².

In a preferred embodiment, the current intensity of the iron or aluminum electrolytic cell or electrocoagulation cell is between 0.1 and 15 A, more preferably the current intensity of the iron or aluminum electrolytic cell is between 1 A and 10 A, most preferably between 3 and 6 A.

In a preferred embodiment, the magnitude of the current density of the iron or aluminum electrocoagulation cell is at least 4 A/m², more preferably at least 20 A/m², more preferably at least 40 A/m², more preferably at least 80 A/m², more preferably at least 120 A/m², more preferably at least 160 A/m², more preferably at least 200 A/m², most preferably 240 A/m². In a preferred embodiment, the magnitude of the current density of the iron or aluminum electrocoagulation cell is at most 600 A/m², more preferably at most 480 A/m², more preferably at most 400 A/m².

In a preferred embodiment, the chemical oxygen demand (COD) of the black water to be treated is at least 3000 mg/L, more preferably a COD of at least 4000 mg/L, more preferably a COD of at least 5000 mg/L, more preferably a COD of at least 6000 mg/L, more preferably a COD of at least 7000 mg/L, more preferably a COD of at least 8000 mg/L, more preferably a COD of at least 9000 mg/L, more preferably a COD of at least 10000 mg/L, more preferably a COD of at least 11000 mg/L, more preferably a COD of at least 12000 mg/L, more preferably a COD of at least 13000 mg/L, more preferably a COD of at least 14000 mg/L, more preferably a COD of at least 15000 mg/L.

In a preferred embodiment, the chemical oxygen demand (COD) of the treated black water is at most 2000 mg/L, more preferably at most 1000 mg/L, more preferably at most 500 mg/L, more preferably at most 400 mg/L, more preferably at most 300 mg/L, more preferably at most 250 mg/L, more preferably at most 200 mg/L, more preferably at most 150 mg/L, more preferably at most 125 mg/L, more preferably at most 100 mg/L, more preferably at most 75 mg/L, more preferably at most 50 mg/L.

In a preferred embodiment, the black water to be treated has a biochemical oxygen demand (BOD) of at least 1000 mg/L, more preferably a BOD of at least 2000 mg/L, more preferably a BOD of at least 3000 mg/L, more preferably a BOD of at least 4000 mg/L, more preferably a BOD of at least 5000 mg/L, more preferably a BOD of at least 6000 mg/L, more preferably a BOD of at least 7000 mg/L, more preferably a BOD of at least 8000 mg/L, more preferably a BOD of at least 9000 mg/L, more preferably a BOD of at least 10000 mg/L.

In a preferred embodiment, the biochemical oxygen demand (BOD) of the treated black water is at most 1000 mg/L, more preferably at most 500 mg/L, more preferably at most 400 mg/L, more preferably at most 300 mg/L, more preferably at most 250 mg/L, more preferably at most 200 mg/L, more preferably at most 150 mg/L, more preferably at most 125 mg/L, more preferably at most 100 mg/L, more preferably at most 75 mg/L, more preferably at most 50 mg/L, more preferably at most 25 mg/L, more preferably at most 20 mg/L, more preferably at most 15 mg/L, more preferably at most 10 mg/L, more preferably at most 5 mg/L.

In a preferred embodiment of the electrolytic cell and/or coagulation cell and/or electro-oxidation cell and the method for using the same is described below:
a) passing the wastewater to be treated through an electrolytic cell which is provided with two metal electrodes with different electronegativities, consisting of coaxial pipes with the inner pipe comprising the more electronegative electrode,
b) performing electrolysis between the two electrodes, such that the more electronegative electrode, which does not wear in a cleaning process, is used to produce hydrogen gas and hydroxyl ions from water, and that the less electronegative electrode, which is an active, wearing electrode in a cleaning process, is used to produce metal ions in a solution to be treated,
c) producing an electric field in the electrolytic cell, causing desired redox reactions. In an electrocoagulation cell, these contaminants will separate from the wastewater by forming and coagulating poorly soluble flocs. In an electro-oxidation cell, oxidative compounds are formed that break down contaminants, and in particular inhibit biological contaminants.
d) Optionally for the electrocoagulation cell, directing the wastewater with said flocs from the electrolytic cell to a separation device for flocs and treated water (effluent).

In a further preferred embodiment, the surface of the electrolytic cell is cleaned regularly. This prevents limescale build-up. Lime deposits lower the efficiency of the electrolytic cells, and consequently also lower the cleaning capacity.

The anode is the outer pipe. Preferably, the anode, at least in the surface, is made of aluminum, iron, stainless steel (SS) or titanium. The choice between aluminum, iron, stainless steel or titanium depends on the contamination of the water to be treated and the intended purpose of the electrolytic cell.

An electrolytic cell with aluminum, iron or steel electrode, preferably aluminum or stainless steel are suitable as electrocoagulation cell. In an electrocoagulation cell, the anode is the electrode with a less electronegative material, wherein metal ions are released to the wastewater. These metal ions, usually aluminum or iron cations, form poorly soluble salts and/or complexes with compounds present in the wastewater. The poorly soluble salts or complexes precipitate and coagulate into larger flocs in the electrocoagulation cell. Thus, the cell produces coagulated flocs of pollution and an aqueous effluent. A separation mechanism, such as a floc tower, is required to separate the floating flocs and the aqueous effluent. Since the anode of an electrocoagulation cell releases metal ions, it is an actively wearing electrode that must be replaced over time. It is advantageous to use it as an outer electrode. This makes it easier to replace the anode. This is also the electrode with the largest surface area, which prevents the build-up of contamination at the anode and promotes the dissolution of metal ions in the wastewater.

An electrolytic cell with titanium or stainless-steel electrode is suitable as an electro-oxidation cell. Oxidizing agents, in particular sodium hypochlorite, are produced at the anode. We note that substances present in the wastewater are oxidized, in contrast to the electrocoagulation cell where the metal surface oxidizes to metallic cations. The oxidizing agents formed in turn oxidize organic substances and biological organisms; so that they strongly promote their degradation. Thus, we note that depending on the choice of electrode material, the cleaning mechanism of the electrolytic cell changes substantially. In the case of a titanium anode, it is preferably coated with platinum. The anode is preferably the outermost cylindrical electrode as it has the largest surface area.

The cathode is the inner pipe. This is the electrode with a more electronegative surface material. Hydrogen gas is produced from water at the cathode, so this is not an actively wearing electrode. Preferably, the cathode is made of steel. Even more preferably, the cathode is made of stainless steel. Alternatively, the cathode may also be made of iron, aluminum, copper or another steel alloy.

The coaxial pipes can be supplied in diameters and lengths that vary depending on a particular application. The diameters determine the space between the two cells where water flows. It is important to dimension this space based on the flow to be processed; taking into account the conductivity and degree of pollution of the wastewater. However, it is important to provide this space sufficiently large to prevent the risk of clogging or greatly increasing pressure drop in the event of contamination.

As the size of a processing plant becomes larger and the flow rate increases, it is advantageous that a sufficient number of cells are connected in parallel.

Preferably, the length is considerably higher than the diameter. Preferably, the ratio of the length over the inner diameter, measured from the inner surface, of the outer pipe is higher than 5, even more preferably higher than 7, most preferably higher than 10.

The combination of the method according to the first aspect and the use of elongated, concentrically nested electrode pipes is surprisingly advantageous to obtain a small, modular arrangement that is sufficiently effective to treat black water, preferably until it can be stored without odor or color nuisance, more preferably until it meets the discharge standards.

In an electrocoagulation cell, the electrolytic cell dissociates water into H⁺ ions and OH⁻ ions. The H⁺ ions absorb electrons and escape from the mixture as hydrogen. Since these H⁺ ions escape faster than the OH⁻ ions, a mildly alkaline solution is created along the cathode. At the anode, metal ions dissolve in the wastewater. These metal ions then form metal hydroxides, which are poorly soluble in water for both iron and aluminum. Organic substances and heavy metals coprecipitate with the formed metal hydroxides. The precipitate rises together with H₂ gas as a floc to the surface of clean water.

The oxidation of iron into Fe²⁺ or Fe³⁺ ions and the purification of the wastewater take place in a cell at a certain point of resonance energy. In other words, the electrical energy that is introduced into a cell must be dimensioned according to the dimensioning and flow of the cell, i.e. the retention time of wastewater in the cell space. The search for a good point in resonance energy has to be done experimentally and then the cell flow is controlled by automation with respect to the wastewater flow. This is considerably more difficult when the surface of the anode rapidly becomes contaminated, since this contamination strongly drives up the resonance energy. It is therefore particularly important to keep the surface of the electrodes sufficiently clean.

The surface of the electrodes can be cleaned according to existing methods. In particular, the electrodes can be cleaned by flow-through, preferably counterflow, with dilution water or treated dilution water when the arrangement is not in use. Even more preferably, this flow-through takes place under higher pressure, which favors cleaning of the surface.

In a further embodiment, the cleaning comprises flushing the electrolytic cell with an axial jet or pressure wave.

This jet or pressure wave can propagate in the wastewater or another liquid medium. Preferably, the jet or pressure wave is produced by contacting the cell axially with a pressurized flushing fluid. Preferably, this is done during a very short period. Preferably, the pressure of the flushing liquid is between 0.5 and 3 bar, even more preferably between 0.6 and 2.5 bar, even more preferably between 0.6 and 2.0 bar, even more preferably between 0.6 and 1.5, even more preferably between 0.8 and 1.2 bar and most preferably between 0.9 and 1.1 bar.

This process produces a pressure wave that propagates axially through the wastewater. This prevents eddies and lateral (in this case in the radial and tangential direction with respect to the coaxial electrodes) mixing. Thus, coagulated flocs are not pulled apart and are only slightly affected. However, the surface does remain clean. The jet can be used at relatively long intervals, for example every minute to every 2 hours. Preferably the intervals are between 5 minutes and 2 hours. The length of the intervals mainly depends on the amount of contamination, which depends on the amount and type of contaminants in the water that can be removed by electrocoagulation.

The flushing liquid can be any liquid, preferably water. Even more preferably recycled “purified” water from the separation device, which is downstream from the electrolytic cell, dilution water or treated dilution water.

In another preferred embodiment, the cleaning comprises producing axial waves by means of vanes. Preferably, the vanes substantially consist of brushes. These brushes give less cause for eddies and break coagulating flocs less. The liquid passes more or less through the brushes, and the flocs stick to the brushes. Coagulation with vane-shaped brushes is thus not strongly prevented, but a clean surface is nevertheless obtained.

These brushes should not touch the surface of the outer pipe. Preferably, the brushes do not abut the surface of the outer pipe. Scrubbing the surface of the outer pipe clean will result in faster wear of the active electrode. The surface is not cleaned by the scrubbing of the brushes against the surface, but by the flow generated by said brushes. In one embodiment, the brushes can move axially to cause this flow. An axial pressure wave results from the axial movement of the brush.

In another embodiment, the brushes are vane-shaped and can rotate, thereby creating axial flow. In a preferred embodiment, the brushes can both move axially and rotate, and are still vane shaped.

Preferably, the brush is used only intermittently. Although the present embodiments attempt to prevent the breaking up of flocs, the cleaning of the anode surface is detrimental to purifying the wastewater. Optimizing the time between cleaning the surface can be done by trial and error and is trivial for a person skilled in the art.

Preferably, the brushes consist of materials which are resistant to both slightly acidic and slightly basic conditions. Preferably, the brushes consist of a non-electrically conductive material. Even more preferably, the brushes are made of polypropylene or polyamide.

In one embodiment, the cell is cleaned intermittently. The cell can thus be used as much as possible with a strict laminar flow pattern, which is beneficial to coagulation. The length of the intervals can be determined by trial and error. In a preferred embodiment, the cell is operated at a constant current intensity, and the cell is cleaned when the voltage necessary to maintain this constant current intensity with respect to a clean cell increases by more than 30%, preferably the increase is more than 25%, even more preferably the increase is more than 20%, even more preferably the increase is more than 15%, most preferably the increase is more than 10%. Preferably, the voltage increase at a constant current intensity is at least 1% before cleaning the electrolytic cell. Even more preferably, the increase is at least 3%, most preferably at least 5%. Allowing a high voltage before cleaning leads to a very high power consumption and/or low consistency in water treatment. Cleaning at very low voltage increases leads to frequent cleaning, which disrupts the flow pattern in the electrolytic cell. Selected values lead to an optimum, in order to achieve a constant water treatment with a relatively low power consumption.

In a preferred embodiment, the electrocoagulation cell is provided with a jet cap. In a preferred embodiment, the electro-oxidation cell is provided with a jet cap. Such electrolytic cell, comprises two coaxial pipe-shaped metal electrodes, an inner and an outer pipe, wherein the inner pipe is coupled to a negative terminal of a power source and the outer pipe is coupled to a positive pole of the power source, with an electrolysis space between the electrodes, the inner pipe being made of a more electronegative material at least in its surface layer than the outer pipe, characterized by a jet cap at the bottom of the electrical cell along one end of the coaxial pipes, provided with at least one radial opening suitable for supplying or discharging the wastewater to the electrolysis space and at least one axial opening with a control valve, suitable for producing a pressure wave which propagates through said electrolysis space with a flushing liquid.

This is a simple set-up that is easy to control and maintain. The continuous cleaning of the surface makes the control of the electrolytic cell easier. The pressure wave can be produced by briefly opening and closing the axial valve. Furthermore, the same electrolytic cell has been preserved. With no contaminants along the outer pipe, electrocoagulation and/or electro-oxidation gives better water purification and more consistent water purification when the electrolytic cells are operational for a long time.

In a preferred embodiment, the jet cap comprises an opening suitable for emptying the electrolysis space of wastewater and flocs.

This is advantageous for the maintenance of the electrolytic cell, for example for the replacement of the actively wearing electrode. In addition, the cell still needs to be cleaned after a while.

Device for removing contaminants from wastewater by means of electrocoagulation with vanes, wherein said partitions are arranged obliquely, preferably at an angle of 0-40°, even more preferably an angle of 10-25°.

A swirling jet can be produced with the aid of oblique partitions. This introduces a limited amount of turbulence into the system. This benefits the cleaning of the surface. Since the eddy propagates through the medium only once, the influence on coagulation in the electrolytic cell is small. Nevertheless, a small angle is preferably used so that flocs are carried along by the eddy rather than pulled apart.

In a further preferred embodiment, the invention comprises a jet cap comprising two radial openings and one axial opening, wherein the radial openings are located at a different height relative to the axis.

The highest radial opening is suitable for the supply of water. The lowest radial opening is suitable for emptying the cell for maintenance. The axial opening is suitable for producing the axial jet. This very simple construction allows efficient operation of the electrolytic cell.

In a further preferred embodiment, the jet cap comprises four partitions, which define four compartments, wherein the radial openings open into opposite compartments, and the axial opening opens into intermediate compartments.

This partially prevents water hammer in the radial openings, especially the feed pipe for the wastewater to be cleaned. Furthermore, the partitions help to direct the pressure wave evenly and axially. This way the flocs are less disturbed by the jet.

Preferably, the inner electrode of the electrocoagulation cell, at least in the surface layer, is made of steel. Steel is advantageous as the alloy can be controlled for the electronegativity. Thus, with a good choice of steel, the difference in electronegativity can be controlled. Preferably, the outer electrode consists of iron or aluminum. Both are inexpensive, easy to process and both iron hydroxide and aluminum hydroxide are poorly soluble in water. Furthermore, iron hydroxide and aluminum hydroxide coagulate well with contaminants such as heavy metals.

In a further embodiment, the electrolytic cell is cleaned by reversing the poles, or rather reversing the potential difference applied to the poles. The anode is then used as the cathode, and the cathode as the anode. This process stops the cleaning effect of the electrolytic cell but allows to quickly prevent the accumulation of dirt and to break down existing dirt. This is particularly advantageous for the iron or aluminum electrocoagulation cell. Preferably, this technique is not used with the titanium electro-oxidation cell, as the titanium electrode is consumed upon changing polarity. These drawbacks can be counteracted by coating.

Preferably, the iron or aluminum electrocoagulation cell is cleaned by means of changing polarity, and the titanium electro-oxidation cell is cleaned by means of the jet hood as described above. The cleaning operation preferably takes place when no black water is being purified. This is usually not a problem as black water is not continuously produced nor treated.

In a third aspect, the invention relates to the use of the method according to the third aspect for treating wastewater on a means of transport. Preferably, this wastewater comprises black water. More preferably, this wastewater comprises black and gray water. This is advantageous since the wastewater does not have to be stored but can be cleaned to a dischargeable quality.

In a preferred embodiment, the means of transport or temporary residence such as a boat, train or aircraft, camper or trailer, bus, submarine or the like. More preferably, the means of transport is a boat or train.

It is desirable to obtain waste processing with a limited volume and weight on such means of transport. In addition, a closed system, not connected to the water network or sewage system, is often a necessity. Finally, it is desirable that the black water, after storage for some time and subject to treatment, can be discharged sufficiently cleanly as surface water and/or sewage water. This is in contrast to storage where contamination builds up and/or bacteria growth, as a result of which specialized processing is often required. This entails an additional cost and additional difficulties, as well as odor, color and storage problems.

In a preferred embodiment the transport means is a train. The method for the treatment of black water according to the first aspect and the closed toilet system according to the second aspect are particularly advantageous for use on a train. Discharge of water on or along train tracks is not desirable; even treated water that meets all standards. As a result, black water from toilets is usually stored and later transferred to a wastewater treatment facility. However, this has several problems. The black water causes odor and storage problems due to, among other things, bacterial growth. The black water cannot be used for flushing the toilet, due to the low water quality, color and odor problems. As a result, additional flushing water is required for toilets, which must also be stored and replenished. In such cases, the present invention advantageously makes it possible to provide only one storage tank, to empty it less regularly, with continuously greatly improved water quality and less or no odor nuisance. The water further meets the requirements for discharge into sewage and rather than processing through specialized wastewater treatment. This allows easier emptying of the storage tank.

In a preferred embodiment, the means of transport is a small boat or pleasure boat. In another preferred embodiment, the means of transport is a train. Such boats and trains usually do not have the space for a large black water reservoir or water treatment installation. It is also particularly important that the black water does not cause any odor nuisance. The advantages mentioned for a train are also increasingly applicable to a boat. In particular, more and more jurisdictions require that black water not be mixed with dilution water; since the dilution of this easily allows the achievement of discharge standards. Processing, reusing and, if necessary, storing black water without diluting it is therefore also becoming more relevant for boats and pleasure boats.

In a fourth aspect, the invention relates to a method for the treatment of black water, comprising the steps of:
a. collecting black water;
b. providing dilution water;
c. activating said dilution water in an electrolytic cell having a titanium electrode, preferably a titanium electro-oxidation cell, obtaining treated dilution water;
d. mixing treated dilution water and said black water, obtaining diluted black water; and
e. treating said diluted black water in an electrocoagulation cell, preferably with an iron or aluminum electrode, so that treated black water is obtained.

When working with dilution water, as according to the fourth aspect, it is advantageous to perform the electro-oxidation step on the dilution water. This has the following advantages:
Before black water can be passed through an electrolytic cell, it is usually first collected in a reservoir, and optionally passed through a macerator pump. This is usually necessary to ensure the proper functioning of the electrolytic cell. However, untreated black water is a breeding ground for bacteria, fungi and the like. As a result, the BOD of black water also increases exponentially during these operations. Mixing black water with treated dilution water strongly inhibits the growth of biological organisms. This also significantly lowers the BOD of the final mixture to be treated and significantly increases the efficiency of the entire process. In addition, odor nuisance is counteracted.
The energy supplied by the electrolytic cell will act on all electrolytes present. In dilution water, this mainly produces desirable oxidizing agents such as hypochlorite and peroxides. Black water contains considerably more electrolytes, which reduces energy efficiency.
The reaction can be better controlled. Black water often shows strong differences in composition, which necessitates more changes in the process parameters of the electro-oxidation cell.

In a preferred embodiment, the invention relates to a method for the treatment of black water, comprising the steps of:
a. collecting black water;
b. grinding the black water,
c. providing dilution water;
d. activating said dilution water in an electrolytic cell having a titanium electrode, preferably a titanium electro-oxidation cell, obtaining treated dilution water;
e. mixing treated dilution water and said black water, obtaining diluted black water; and
f. treating said diluted black water in an electrocoagulation cell, preferably with iron or aluminum electrode, so that treated black water is obtained.

Grinding the black water reduces the particle size of the solid particles in the liquid phase.

In a preferred embodiment, the dilution water is surface water or rainwater, preferably surface water. A particular advantage of the present invention is that water can be collected on site and this water can be used advantageously for purification. Thus, surface water can be collected as needed. Alternatively, rainwater can be collected and used as needed.

Preferably, a chloride salt is added to the dilution water, especially when it is fresh water or rainwater, before this dilution water is treated in the titanium electrolytic cell. Even more preferably, the chloride salt is sodium chloride. Adding a salt is advantageous because it increases the conductivity of brackish water, which reduces the required current intensity. The presence of sodium chloride is advantageous as it produces a small amount of hypochlorite (ClO⁻) under the influence of the titanium electrolytic cell, especially sodium hypochlorite (NaClO). In this way, bleach is obtained, which has a disinfecting and oxidizing effect.

In a preferred embodiment, the salt concentration in the dilution water is at least 0.014 mol/L Cl, more preferably the salt concentration in the dilution water is at least 0.028 mol/L Cl. Explicitly adding sodium chloride makes it possible to better control its concentration in the dilution water. The minimum salt concentration ensures on the one hand a sufficient conductivity of the water, which is necessary for the proper functioning of the electrolytic cells. On the other hand, this ensures a minimum of chloride ions, so that sufficient hypochlorite can always be formed in the electro-oxidation cell.

Preferably, the ratio of treated dilution water to black water in step d. mixing treated dilution water and black water is at least 2:1, more preferably at least 2.5:1, more preferably at least 3:1, even more preferably at least 3.5:1, preferably about 4:1.

Preferably the ratio of treated dilution water to black water in step d mixing treated diluent water and black water is at most 10:1, more preferably at most 8:1, more preferably at most 6:1, even more preferably at least 5:1, most preferably about 4:1.

### EXAMPLES

### Example 1

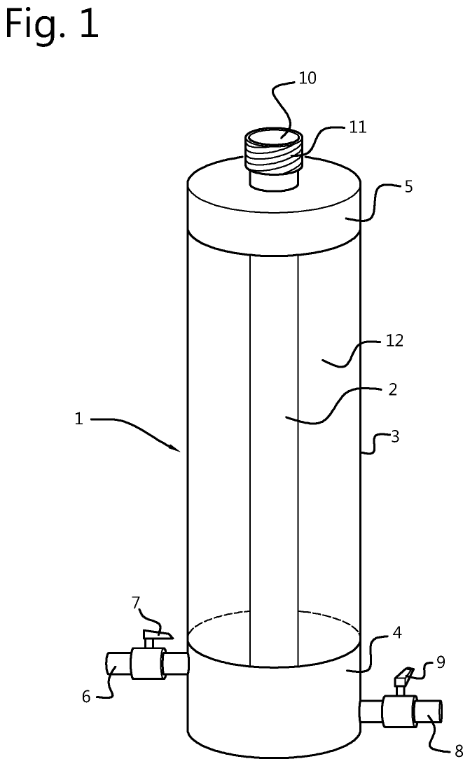

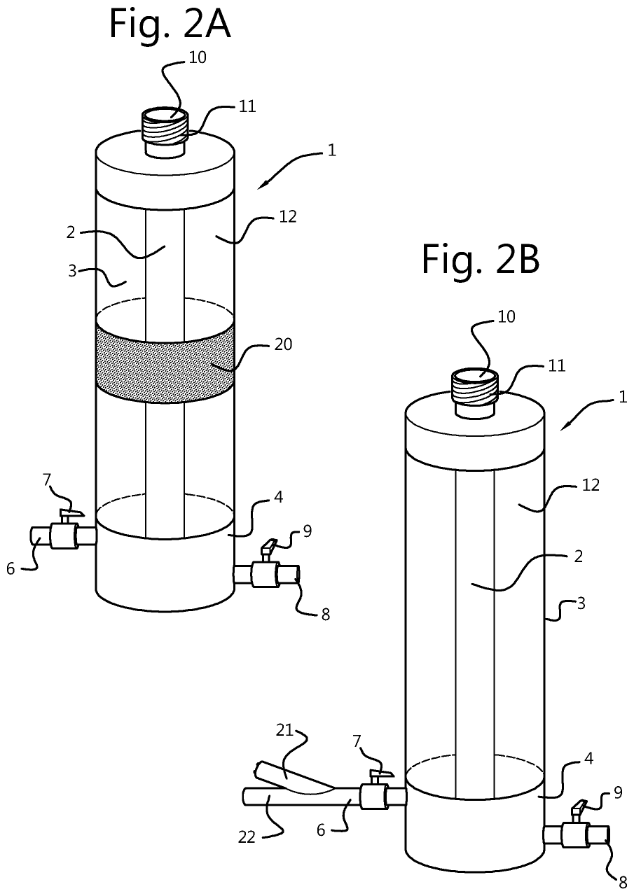

An embodiment of the electrolytic cell 1 is shown in FIG. 1. This electrolytic cell 1 consists of two concentric pipes, the inner 2 consisting of steel and the outer 3 consisting of iron. Here, the outer electrode 3 is more electronegative. The inner electrode 2 has a radius of 4 cm and a length of 100 cm. The outer electrode 3 has a radius of 7 cm and a length of 100 cm. The concentric pipes 2, 3 are attached at the bottom to a base 4, and at the top to a top 5.

This base holds the electrodes in their concentric position and is radially equipped with two valves 7, 9. A first valve 7 is suitable for supplying wastewater to the electrolytic cell. A second, lower valve 9 is suitable for emptying the electrolytic cell 1 for maintenance. This is desirable for the complete cleaning of the cell or replacement of an affected outer electrode 3.

The top 5 has two concentric fastening rings at the bottom. These connect closely to the electrodes and keep them in a fixed position. The top is provided centrally at the top with a pipe connection 10, 11. This is intended for the discharge of water containing flocs of coagulated contaminants to a separation device, preferably a separation tower.

The effluent arrives at the bottom and is passed through cell 1 between the concentric electrodes 12. In the cell under the influence of redox reactions, contaminants coagulate into flocs. In the top, the water is conducted from between the two electrodes to a central position 10 and is discharged along this central position 10 to a separation tower. The cell can handle flow rates between 5 and 1000 l/h. The current intensity in the cell is between 1 and 250 amps. The electrical voltage in the cell is between 1 and 60 volts. The rate of coagulation in the cell is proportional to the electrical power in the cell. The average consumption of the electrolytic cell is 1.5 kWh/m³. The maximum consumption of the electrolytic cell is 5 kWh/m³.

For an application with low flow rates, such as a small boat, bus or train, the cell usually needs to handle flow rates between 5 and 50 l/h. The current intensity in the cell is between 1 and 9 amps. The electrical voltage in the cell is between 1 and 30 volts. The rate of coagulation in the cell is proportional to the electrical power in the cell. The average consumption of the electrolytic cell is 1.5 kWh/m³. The maximum consumption of the electrolytic cell is 5 kWh/m³. These values are desirable to optimize space utilization as well as cell operation for such flow rates. For applications with a high flow rate, such as a cruise ship, a cell is needed that can handle flow rates between 50 and 1000 l/h. The current intensity in the cell is between 3 and 250 amps. The electrical voltage in the cell is between 1 and 60 volts. The rate of coagulation in the cell is proportional to the electrical power in the cell. The average consumption of the electrolytic cell is 1.5 kWh/m³. The maximum consumption of the electrolytic cell is 5 kWh/m³.

The cleaning capacity of the cell was tested. Heavy metals were almost completely removed from the wastewater. Many organic compounds were also not found in the purified water. The chemical oxygen demand of the water (COD) decreased considerably.

In the case of salt water, the water was only partially desalted. Alkali metal ions were substantially not removed. Alkaline earth metal ions were partially removed, typically between 30 and 60%. Ions of other metals, mainly heavy metals, including Ni, Co, Cu, Zn, Ag and Sn are almost completely removed. More than 95% of the ions of these metals are removed from the wastewater. The cleaning capacity depends on the electrical power acting on the cell.

If the cell 1 is not continuously cleaned, flocs also coagulated along the outer, active electrode 3. There, these flocs form a film. Once this contaminating layer forms along the surface, it grows rapidly due to coagulation. This layer of contaminants along the electrode lead to a considerably higher current consumption for the same cleaning capacity of cell 1. As the layer grows rapidly, this current consumption also increases rapidly. In the case of a heavily contaminated active electrode, an increase in the electrical power is not sufficient to guarantee the cleaning capacity of the cell. Cell 1 is operated at a constant current intensity. When the voltage rises by more than 10% compared to the clean electric cell, said cell was cleaned.

### Example 2

A titanium electrolytic cell was prepared as described in Example 1, but with a titanium outer pipe and a steel inner pipe. The titanium outer pipe has a platinum coating.

River water is passed through a membrane. This membrane removes colloidal iron particles. Table salt (NaCl) is then added to the filtered river water. The filtered river water with increased salinity is then passed through the titanium electrolytic cell. The current intensity of the electrolytic cell is 6 A and the flow rate through this cell is 10 L/h.

Black water from a vacuum toilet is pumped into the same reservoir by means of a shredder pump. Treated river water is added to the reservoir until the ratio of treated river water to black water is 4:1. The contents of the reservoir are mixed by a mixer and passed uniformly through an iron electrolytic cell as described in Example 1. The current intensity of the electrolytic cell is 3-6 A and the flow rate through this cell is 10 L/h. After this, the coagulated flocs and the treated black water are mechanically separated in a floc tower.

The chemical oxygen demand between the iron coagulation cell influent and the iron coagulation cell effluent decreased by 64%.

### Example 3

The setup of Example 2 was reused. However, the effluent from the iron coagulation cell was passed through the iron coagulation cell a second time. A relative reduction in chemical oxygen demand of more than 65% was also observed in this step. The treated water has a low chemical oxygen demand and biochemical oxygen demand, well below the limits for discharge into surface water.

### Example 4

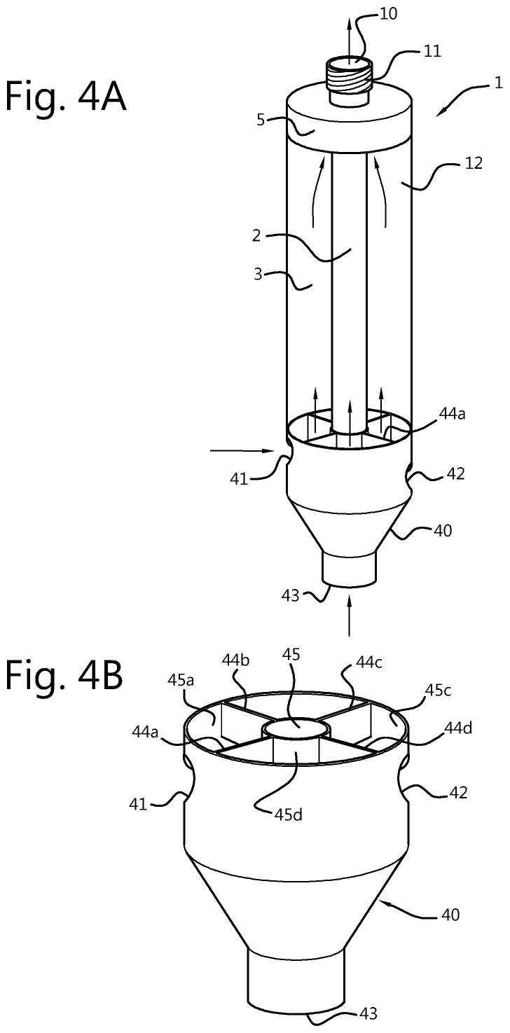

The same electrolytic cell 1 as in the first example, the base being replaced by a jet cap 40 as shown in FIG. 4A. The jet cap 40 is shown in detail in FIG. 4B. Like the base in Example 1, this jet cap 40 has two radial connections, one for supplying wastewater 41 and one for emptying the tank 42. However, the jet cap has a third axial connection 43 on the same axis as the concentric pipes. The jet cap is provided with four radial partitions 44a, 44b, 44c, 44d, resulting in four different semi-open compartments 45a, 45b, 45c, 45d.

The first compartment is connected to the influent supply 45a. The third compartment 45c is connected to the valve for emptying the tank. The second 45b and fourth compartment 45d are connected to the axial connection. The radial partitions 44a, 44b, 44c, 44d do not extend all the way to the bottom of the jet cap 40. All the compartments are connected to the axial connection 43 completely at the bottom of the jet cap 40. This creates a jet in each of the four compartments 45a, 45b, 45c, 45d. This also causes the influent water that enters the cell to be sucked along, which increases the acceleration and the flow. However, the partitions 44a, 44b, 44c, 44d continue along the influent connection 41. This creates an axial wave and partially counteracts water hammer.

In use, a flushing fluid was pushed through cell 1 at a pressure of 1 bar along this axial connection 43. The flushing liquid contains purified water. Thanks to the high pressure, the flushing fluid is pushed through the cell, creating a jet that moves through the cell. A negative pressure is created behind this jet, which pulls the effluent with it. This creates some turbulence.

The cell was rinsed for 1 minute every 30 minutes. This significantly prevented the formation of the contaminating layer.

### Example 5

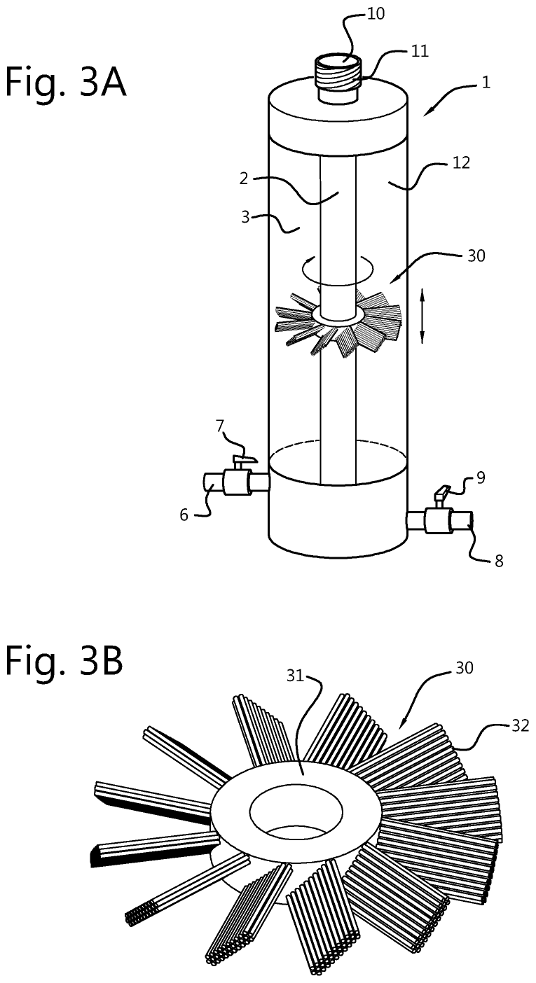

The same electrolytic cell 1 as in the first example, further provided with a rotatable brush 30, is shown in FIG. 3A. The brush is shown in detail in FIG. 3B. The brush can rotate around the inner pipe 2, as well as move axially along this pipe by means of a fastening ring 31. The brush bristles 32 consist of a plastic such as: polypropylene or polyamide, and do not come into contact with the inner surface of the outer electrode 3. The brush 30 is tilted at an angle of 45°.

The surface of the outer electrode 3 was not cleaned by the brushing of a brush 30 against this surface, since the brush 30 does not touch this surface. The turbulence and flow, which the brush 30 formed as a vane causes, provides an axial flow along the inner surface of the outer electrode 3. This flow reduces the coagulation of the flocs against this surface. The flocs are mainly carried by the flow to the separation tower. Thanks to the angle and the existence of space between each row of brush bristles 32, only a small part of the flocs is carried along by the brush 30. Nevertheless, some of the coagulated flocs get stuck along the brush 30. When too many flocs coagulate on the brush 30, they are released by the flow and are carried along with the water.

### Example 6

The same electrolytic cell 1 as in the first example, wherein the cell is cleaned by rinsing with warm water. To this end, the cell 1 is first emptied, with the aid of the outlet 8 which is lower than the inlet for wastewater 6. The wastewater is collected and later recycled to inlet 6.

The empty electrolytic cell 1 is rinsed with warm water. Detergents, surfactants, pH regulators, silica and other substances can also be added to the warm water for good cleaning. In this example, water containing citric acid and a small amount of detergent is used. An acidic solution, such as by adding citric acid to water, is particularly advantageous to prevent scale build-up on the electrodes. The result is good cleaning which almost completely removes the contaminating film. The cell 1 is rinsed every 2 hours.

If limescale or deposits build up along the electrodes, they can easily be cleaned by switching off the electrolytic cell and allowing acidic water to act for a longer period of time, for example 4 hours.

If shutting down the cell for an extended period of time is not desirable or possible, one can also use a jet cap as described in Example 7. Preferably, a jet wave of acidic water is sent through the cell. Such a cleaning program achieves a good cleaning in a shorter time, for example 15 minutes to 1 hour.

### Example 7

The same electrolytic cell 1 as in the fourth example, wherein the jet cap is adapted to a rotating jet cap. A rotating jet cap has a structure like the jet cap in Example 4, but the partitions have been partially replaced by a rotating nozzle near the axis of the electrolytic cell. This rotating nozzle produces a jet wave with cleaning liquid, with which a surprisingly good cleaning of the electrodes was obtained.

The jet cap allows, on the one hand, to admit influent into the electrocoagulation reactor and, on the other hand, to supply a jet with cleaning liquid under pressure.

This jet is supplied at a pressure of 2 to 16 bar to the connection of the cleaning liquid of the nozzle of the jet cap. The cleaning liquid may comprise water, wastewater, warm water, organic solvents, detergents and surfactants, depending on the application. Preferably, the cleaning fluid is a solution of acid in water.

Just like the base in examples 1 and 4, the jet cap has two radial connections, one for supplying wastewater and one for emptying the tank. The jet cap also has a third axial connection on the same axis as the concentric pipes. The jet cap is equipped with a rotating nozzle for producing a jet. This nozzle is arranged so that the jet propagates upwards from the bottom to the top through the jet.

The nozzle consists of a housing, provided with a connection for the supply line of the cleaning fluid and an outlet for the cleaning fluid and a nozzle body through which the cleaning fluid flows. The third axial connection of the jet cap is connected to the nozzle entrance so that the cleaning fluid can be supplied through it.

The nozzle body has a spherical end. The nozzle body is provided in the housing and is mounted at the spherical end on a pan-shaped bearing which is provided around the outlet of the housing. The nozzle body is made to rotate by the flow of cleaning liquid through the housing. The longitudinal axis of the nozzle body revolves around a generated cone. The bearing supporting the nozzle body is formed by a depression arranged in the inner wall of the housing, concentric with respect to the outlet of the housing.

With the help of this improved cleaning technique, the flow of wastewater that is cleaned by the coagulation cell could be increased to 2-5 m³ of wastewater per hour. The cell remained sufficiently clean for long-term use.

### Example 8

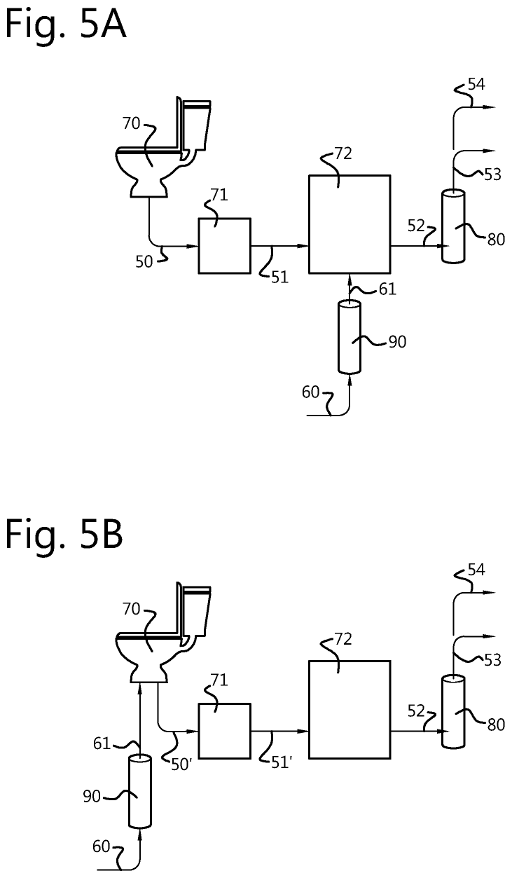

An arrangement as shown in FIG. 5A is used to clean black water 50 from a toilet 70 suitable for a pleasure boat.

After use, the toilet 70 is vacuum-drawn and the black water is first macerated by a macerator pump 71 and pumped through to a reservoir 72. Treated dilution water 61 is contained in the reservoir 72. The dilution water is surface water 60, which has been treated by means of a titanium electro-oxidation cell 90. The titanium electro-oxidation cell is the same cell with the same process parameters as described in example 2. The treated dilution water contains oxidizing agents, which strongly inhibits the growth of bacteria and other organisms in the reservoir. The ratio of treated dilution water to black water in the reservoir is 4:1 by volume. The diluted black water 52 is passed through iron electrocoagulation cell 80. The treated black water 53 can be discharged immediately or optionally post-treated. The coagulated flocs 54 are separated by means of a mechanical filter.

### Example 9

An arrangement as shown in FIG. 5B is used to clean black water from a toilet 70 suitable for a pleasure boat. The setup is very similar to the setup in Example 8. However, the toilet 70 is not vacuum drawn but flushed with treated dilution water 61 at a ratio of treated dilution water to black water of 4:1. The diluted black water is macerated in its entirety by the macerator pump and pumped through to the reservoir. This difference requires more flow through the macerator pump but shows a lower BOD of the diluted black water 52 coming from reservoir 72. The diluted black water then undergoes the same treatment as in Example 8.

### Example 10

The setup of Example 8 is changed by closing the water flow. This is achieved by using treated wastewater 53 as (untreated) dilution water 60.

### Example 11

The setup according to Example 9 is further modified, by closing the water flow and providing a post-treatment with the titanium oxidation cell 90. To this end, treated black water 53 is used as dilution water 60 and passed through the titanium oxidation cell 90. This post-treated black water or treated dilution water 61 can then be stored in a reservoir without odor nuisance. When flushing the toilet, this post-treated black water or treated dilution water can be used as transparent and odorless flushing water. Furthermore, no additional titanium electrolytic cell is required for this post-treatment.

### Example 12

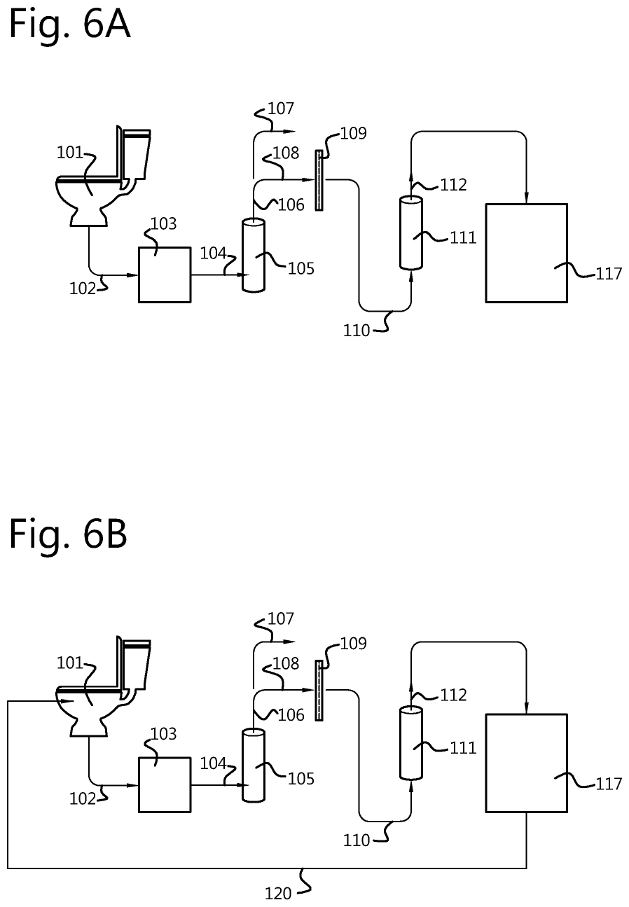

FIG. 6A shows an embodiment of a treatment method according to the first aspect. Black water, mixed with a small amount of flushing water, from a toilet 101 is discharged along toilet drain 102 to a macerator pump 103. Macerator pump 103 grinds the black water and pumps the whole via the macerator pump outlet 104 to electrocoagulation cell 105. Electrocoagulation cell 105 consists of concentric cylindrical electrodes. The wearing electrode is an iron or aluminum electrode on the outside. Electrocoagulation effluent with coagulated flocs 106 floating thereon together exit the electrocoagulation cell. Since the coagulated flocs or electrocoagulation sludge 107 floats on top of the electrocoagulation effluent 108, they are easily separated. The electrocoagulation effluent 108 is passed through a 25 μm mesh filter 109 to ensure that as much colloidal particles as possible are removed from the water.

The filtered coagulation effluent 110 is fed to electro-oxidation cell 111. The electro-oxidation cell 111 is a concentric cylindrical electrolytic cell having a titanium electrode as an outer electrode. The electro-oxidation effluent 112 is stored in storage tank 117.

### Example 13

FIG. 6B shows an embodiment of a treatment method according to the first aspect and a closed toilet system according to the second aspect. FIG. 6B concerns the same arrangement as FIG. 6A but treated black water from storage tank 117 is supplied via fluid connection 120 to toilet 101 where it is used as flushing water.

### Example 14

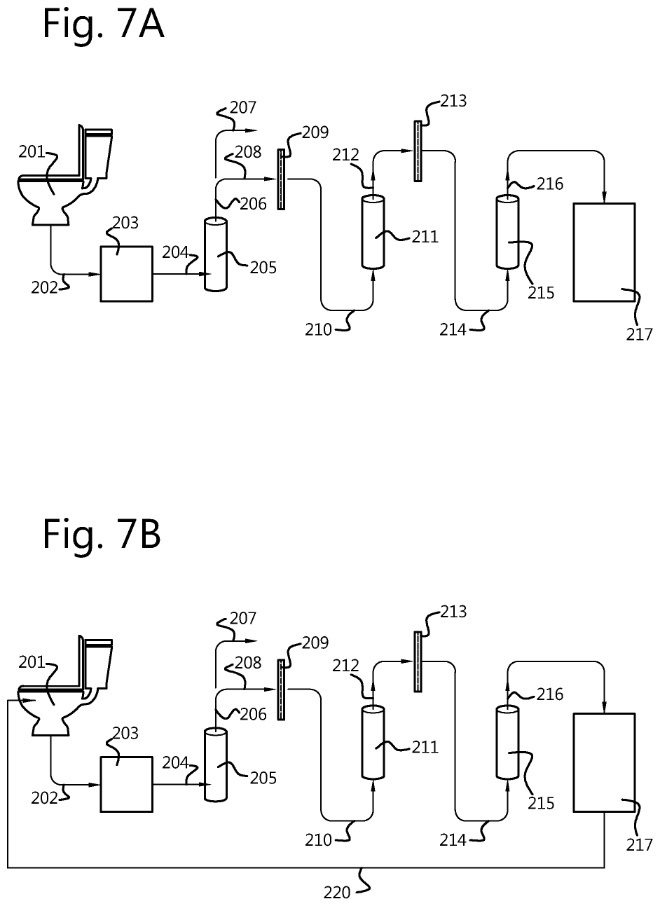

FIG. 7A shows an embodiment of a treatment method according to the first aspect. Black water, mixed with a small amount of flushing water, from a toilet 201 is discharged along toilet drain 202 to a macerator pump 203. Macerator pump 203 grinds the black water and pumps the whole via the macerator pump outlet 204 to electrocoagulation cell 204. Electrocoagulation cell 204 consists of concentric cylindrical electrodes. The wearing electrode is an iron or aluminum electrode on the outside. Electrocoagulation effluent with coagulated flocs 206 floating thereon together exit the electrocoagulation cell. Since the coagulated flocs or electrocoagulation sludge 207 floats on top of the electrocoagulation effluent 208, they are easily separated. The electrocoagulation effluent 208 is passed through a 25 μm mesh filter 209 to ensure that as much colloidal particles as possible are removed from the water. The filtered coagulation effluent 210 is fed to electro-oxidation cell 211. The electro-oxidation cell 211 is a concentric cylindrical electrolytic cell having a titanium electrode as an outer electrode.

The electro-oxidation effluent 112 is filtered through second filter 213 with a mesh size of 0.2 μm. The filtered electro-oxidation effluent 214 is then passed through a sorption column 215. Sorption column 215 is filled with activated carbon. The sorption effluent 216 is then stored in storage tank 217.

### Example 13

FIG. 7B shows an embodiment of a treatment method according to the first aspect and a closed toilet system according to the second aspect. FIG. 7B concerns the same arrangement as FIG. 7A but treated black water from storage tank 217 is supplied via fluid connection 220 to toilet 201 where it is used as flushing water.

### Example 15

The process of Example 12, FIG. 6A, was performed with an electro-oxidation cell with titanium (Ti) electrode. In Example 15, this process was repeated with an electro-oxidation cell with stainless steel (SS) electrode.

The electrocoagulation cell was arranged with 15 mm (measured by a radial) between the concentric inner and outer electrodes. The wastewater flow rate was 10 L/h with a current intensity of 3A.

The electro-oxidation cells for both examples were arranged with 3 mm (measured by a radial) between the concentric inner and outer electrodes. The wastewater flow rate was 1 L/h, again with a current intensity of 3A.

Black water with chemical oxygen demand (COD), biological oxygen demand (BOD), nitrogen content (TN) and phosphorus content (TP) was purified according to Examples 12 and 15. The results are shown in Table 1.

TABLE 1
COD, BOD, TN and TP of influent and effluent
according to Example 12 and 15.

| | | Example | Example | Example | Example |
|---|---|---|---|---|---|
| | Black water | 12 | 15 | 12 | 15 |
| | (influent) | (Ti) | (SS) | (Ti) | (SS) |
| | mg/L | mg/L | mg/L | % | % |
| COD | 5569 ± 32 | 413 ± 10 | 364 ± 12 | 92.6 | 93.5 |
| BOD | 1717 ± 163 | 111 ± 8 | 105 ± 10 | 92.7 | 93.1 |
| TN | 179 ± 3 | 64.9 ± 0 | 63.8 ± 1.8 | 63.7 | 64.4 |
| TP | 24.95 ± 0.5 | 0.99 ± 0.01 | 0.28 ± 0 | 96.1 | 98.9 |

Black water with a high content of E. Coli and Enterococcus bacteria was purified according to Examples 12 and 15. The results are shown in Table 2. After treatment with the electro-oxidation cell, complete disinfection is achieved for both E. Coli and Enterococcus.

TABLE 2
CFU for bacteria from influent and effluent
according to Examples 12 and 15.

| | Black water | Example 12 | Example 15 |
|---|---|---|---|
| | (influent) | (Ti) | (SS) |
| | log CFU/100 ml | log CFU/100 ml | log CFU/100 ml |
| E. Coli | 7.0 | 0.0 | 0.0 |
| Enterococcus | 6.3 | 0.0 | 0.0 |

1. Method for the treatment of black water, comprising the steps of:
a. collecting black water;
b. treating said black water in an electrocoagulation cell with iron or aluminum electrode, such that electrocoagulation effluent and electrocoagulation sludge are obtained;
c. separating the electrocoagulation sludge from the electrocoagulation effluent;
d. optionally filtering the electrocoagulation effluent, preferably with a mesh size smaller than 50 pm, obtaining filtered effluent,
e. disinfecting said electrocoagulation effluent in an electro-oxidation cell with a titanium or stainless-steel electrode, obtaining disinfected effluent.

2. The method for the treatment of black water according to claim 1, wherein the obtained disinfected effluent is post-treated.

3. The method for the treatment of black water according to claim 1, wherein the disinfected effluent, optionally post-treated, is used for flushing a toilet.

4. The method for the treatment of black water according to claim 1, comprising the steps of:
a. flushing a toilet with recycled treated black water, thereby obtaining black water,
b. treating said black water in an electrocoagulation cell with iron or aluminum electrode, such that electrocoagulation effluent and electrocoagulation sludge are obtained;
c. separating the electrocoagulation sludge from the electrocoagulation effluent;
d. filtering the electrocoagulation effluent, preferably with a mesh size of 25 pm, obtaining filtered effluent,
e. disinfecting said electrocoagulation effluent in an electro-oxidation cell with a titanium electrode, obtaining disinfected effluent.

5. The method for the treatment of black water according to claim 1, wherein the obtained disinfected effluent is post-treated, wherein the post-treatment comprises a filtration step with a smaller mesh size than step c.

6. The method for the treatment of black water according to claim 1, wherein the obtained disinfected effluent is post-treated, wherein the post-treatment comprises a treatment with activated carbon.

7. The method for the treatment of black water according to claim 1, wherein the obtained disinfected effluent is post-treated, the post-treatment successively comprising a filtration step and an activated carbon treatment, wherein the filtration step has a smaller mesh size than step c.

8. The method for the treatment of black water according to claim 1, wherein the electro-oxidation cell is used with a current density of at least 4 A/m2.

9. The method for the treatment of black water according to claim 1, wherein the electrocoagulation cell is used with a current density of at least 4 A/m2.

10. The method for the treatment of black water according to claim 1, wherein the disinfected effluent, after optional post-treatment, is stored.

11. The method for the treatment of black water according to claim 10, wherein the stored water has a chemical oxygen demand (COD) of up to 500 mg/L.

12. Closed toilet system comprising:
a toilet, the toilet having a flushing water inlet and a toilet outlet,
a macerator pump, the macerator pump having a macerator pump inlet and a macerator pump outlet, the toilet outlet being in fluid communication with the macerator pump outlet,
an electrocoagulation cell with iron or aluminum electrode, provided with a separation mechanism for separating electrocoagulation effluent and sludge, the electrocoagulation cell having an electrocoagulation inlet, a sludge outlet, and an effluent outlet,
optionally a first filter, the first filter being provided for filtering the effluent outlet, wherein the first filter has a mesh size of less than 50 pm,
an electro-oxidation cell with titanium or stainless-steel electrode, which has an electro-oxidation inlet and an electro-oxidation outlet, wherein the electro-oxidation inlet is in fluid communication with the effluent outlet downstream from the filter, and
a storage tank, wherein the electro-oxidation outlet is in fluid communication with the storage tank, and wherein the storage tank is in fluid communication with the flushing water inlet of the toilet.

13. The closed toilet system according to claim 9, the closed toilet system comprising a second filter, the second filter being provided for filtering the electro-oxidation outlet, wherein the second filter has a mesh size smaller than 1 pm.

14. The closed toilet system according to claim 9, the closed toilet system further comprising a sorption column, the sorption column comprising an activated carbon column, the sorption column comprising a sorption inlet and sorption outlet, wherein the sorption inlet is in fluid communication with the electro-oxidation outlet.

15. Use of the method for the treatment of black water according to claim 1 on a boat, train, aircraft, camper, trailer, bus, submarine or drilling platform, preferably a train.

16. Use of the closed toilet system according to claim 12 on a boat, train, aircraft, camper, trailer, bus, submarine or drilling platform, preferably a train.
